(19) United States
(12) Patent Application Publication
(10) Pub. No.: US 2012/0217444 A1
(43) Pub. Date: Aug. 30, 2012

(54) COMPOSITION AND METHOD FOR INHIBITING PREMATURE POLYMERIZATION

(76) Inventors: Shengxia Liu, Shanghai (CN); Wenqing Peng, Shanghai (CN); Mary Catherine King, Kingwood, TX (US); Sherif Eldin, Bellaire, TX (US); John Link, Humble, TX (US)

(21) Appl. No.: 13/036,605

(22) Filed: Feb. 28, 2011

(51) Int. Cl. C09K 15/32

(52) U.S. Cl. 252/400.53; 252/400.1; 252/400.54

(57) ABSTRACT

The invention relates to composition comprising: at least one free radical polymerizable vinyl compound; and an active amount of inhibition composition comprising metal ions, halogen ions and a ligand having a donor atom selected from oxygen, nitrogen, sulfur, phosphorus and a combination thereof, the metal ions being selected from ions of Ti, Mo, Re, Ru, Fe, Rh, Ni, Pd, Co, Os, Cu and any combination thereof; wherein the composition is free of a nitroxyl compound of a secondary amine having no hydrogen atom on α-C atom. A method for inhibiting the premature polymerization of at least one free radical polymerizable vinyl compound, comprising: adding an active amount of the inhibition composition to the at least one free radical polymerizable vinyl compound.

### BACKGROUND

The invention relates generally to compositions and methods for inhibiting premature polymerization. More particularly, the invention relates to compositions and methods for inhibiting premature polymerization of free radical polymerizable vinyl compounds.

It is known that many unsaturated compounds are prone to polymerization proceeding under free radical conditions. For example, vinylaromatic compounds, such as styrene or α-methylstyrene, must thus be stabilized by suitable stabilizers or polymerization inhibitors in order to prevent premature polymerization during purification by distillation of the crude products obtained on a large scale. Customarily, the stabilizers or polymerization inhibitors are added to the crude products to be distilled before or during the purification step.

U.S. Pat. No. 6,200,460 discloses a substance mixture comprising (A) vinyl-containing compounds, (B) an active amount of a mixture inhibiting the premature polymerization of the vinyl-containing compounds, comprising (i) at least one N-oxyl compound of a secondary amine which carries no hydrogen atoms on the α-C atoms, and (ii) at least one iron compound, (C) if appropriate nitro compounds, and (D) if appropriate costabilizers.

U.S. Pat. No. 6,475,348 relates to a mixture containing one or more vinyl-containing compounds as component (A) and, as a further component, a stabilizer (B) which contains one or more readily volatile nitroxyl compounds of a secondary amine having no hydrogen atoms on the α-carbon atoms as component (b₁), one or more sparingly volatile nitroxyl compounds of a secondary amine having no hydrogen atoms on the α-carbon atoms as component (b₂), if required one or more aromatic nitro compounds as component (b₃) and, if required, one or more iron compounds as component (b₄).

In both of U.S. Pat. No. 6,200,460 and U.S. Pat. No. 6,475,348, nitroxyl compounds of a secondary amine having no hydrogen atoms on the α-carbon atoms are necessary and major components. Nitroxyl compounds are usually relatively expensive and are not desirable in some applications. In addition, since in large-scale industrial processes even small portions of polymers accumulate to yield large amounts of undesirable byproducts, there is always a need for cheap and effective polymerization inhibitors.

Therefore, there is a need for new compositions and methods for inhibiting premature polymerization.

### BRIEF DESCRIPTION

In one aspect, the invention relates to a composition comprising: at least one free radical polymerizable vinyl compound; and an active amount of an inhibition composition comprising metal ions, halogen ions and a ligand having a donor atom selected from oxygen, nitrogen, sulfur, phosphorus and a combination thereof, wherein the metal ions are selected from ions of Ti, Mo, Re, Ru, Fe, Rh, Ni, Pd, Co, Os, Cu and any combination thereof; wherein the composition is free of a nitroxyl compound of a secondary amine having no hydrogen atom on α-C atom.

In another aspect, the invention relates to a method for inhibiting the premature polymerization of at least one free radical polymerizable vinyl compound, comprising: adding an active amount of inhibition composition to the at least one free radical polymerizable vinyl compound, the inhibition composition comprising metal ions, halogen ions and a ligand having a donor atom selected from oxygen, nitrogen, sulfur, phosphorus and a combination thereof, wherein the metal ions are selected from ions of Ti, Mo, Re, Ru, Fe, Rh, Ni, Pd, Co, Os, Cu and any combination thereof; and wherein the composition is free of a nitroxyl compound of a secondary amine having no hydrogen atom on α-C atom.

In another aspect, the invention relates to a composition comprising: at least one free radical polymerizable vinyl compound; and an active amount of an inhibition composition comprising metal ions, halogen ions and a ligand having a donor atom selected from oxygen, nitrogen, sulfur, phosphorus and a combination thereof, wherein the metal ions are selected from ions of Ti, Mo, Re, Ru, Fe, Rh, Ni, Pd, Co, Os, Cu and any combination thereof; wherein when the metal ions comprise Fe ions, the composition is free of a nitroxyl compound of a secondary amine having no hydrogen atom on α-C atom.

### DETAILED DESCRIPTION

In one aspect, the invention relates to a composition comprising: at least one free radical polymerizable vinyl compound; and an active amount of inhibition composition comprising metal ions, halogen ions and a ligand having a donor atom selected from oxygen, nitrogen, sulfur, phosphorus and a combination thereof, wherein the metal ions are selected from ions of Ti, Mo, Re, Ru, Fe, Rh, Ni, Pd, Co, Os, Cu and any combination thereof; wherein the composition is free of a nitroxyl compound of a secondary amine having no hydrogen atom on α-C atom.

In another aspect, the present invention relates to a method for inhibiting the premature polymerization of at least one free radical polymerizable vinyl compound, comprising: adding an active amount of inhibition composition to the at least one free radical polymerizable vinyl compound, the inhibition composition comprising metal ions, halogen ions and a ligand having a donor atom selected from oxygen, nitrogen, sulfur, phosphorus and a combination thereof, wherein the metal ions are selected from ions of Ti, Mo, Re, Ru, Fe, Rh, Ni, Pd, Co, Os, Cu and any combination thereof; and wherein the composition is free of a nitroxyl compound of a secondary amine having no hydrogen atom on α-C atom.

In another aspect, the invention relates to a composition comprising: at least one free radical polymerizable vinyl compound; and an active amount of an inhibition composition comprising metal ions, halogen ions and a ligand having a donor atom selected from oxygen, nitrogen, sulfur, phosphorus and a combination thereof, wherein the metal ions are selected from ions of Ti, Mo, Re, Ru, Fe, Rh, Ni, Pd, Co, Os, Cu and any combination thereof; wherein when the metal ions comprise Fe ions, the composition is free of a nitroxyl compound of a secondary amine having no hydrogen atom on α-C atom.

Preferred free radical polymerizable vinyl compounds are those of the formula (I)

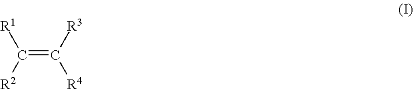

where: each of R¹, R², R³ and R⁴ independently of each other is hydrogen, C₁-C₆-alkyl, C₂-C₆-alkenyl, unsubstituted or substituted aromatic or heteroaromatic radicals or halogen, with the condition that not more than two of these radicals at the same time are unsubstituted or substituted aromatic or heteroaromatic radicals, or R¹ and R³ or R² and R⁴ together form a saturated or unsaturated C₃-, C₄-, C₅- or C₆-alkylene bridge, in which up to two nonadjacent C atoms can be replaced by N, NH, N(C₁-C₄-alkyl), N(C₆-C₁₀-aryl) or oxygen.

The C₁-C₆-alkyl radicals include the linear alkyl chains from methyl through ethyl up to hexyl but also the corresponding branched radicals. Possible C₂-C₆-alkenyl radicals are likewise ethenyl, propenyl etc. up to hexenyl and the groups branched in the saturated moiety. Aromatic or heteroaromatic and unsubstituted and substituted groups which may be mentioned, for example, are phenyl, pyridyl, alkylphenyl or -pyridyl, such as methylphenyl or -pyridyl or ethylphenyl or -pyridyl, alkenylphenyl or -pyridyl, such as vinylphenyl or vinylpyridyl, carboxyphenyl or -pyridyl, formylphenyl or -pyridyl, sulfophenyl or -pyridyl, hydroxyphenyl or -pyridyl, aminophenyl or -pyridyl, nitrophenyl or -pyridyl, but also naphthyl or naphthyl substituted by alkyl, alkenyl, carboxyl, formyl, sulfo, hydroxyl, amino or nitro groups. The halogen radical customarily used is fluorine or chlorine, occasionally also bromine.

If, for example, compounds each having an aromatic or heteroaromatic radical on the one hand and a C₁-C₆-alkyl on the other hand are taken into consideration, and, if the remaining two radicals from R¹, R², R³ and R⁴ are hydrogen, compounds such as α-methylstyrene (2-phenyl-1-propene), the two β-methylstyrene isomers (cis- and trans-1-phenyl-1-propene), α-ethylstyrene (2-phenyl-1-butene), the two β-ethylstyrene isomers (cis- and trans-1-phenyl-1-butene) up to α-hexylstyrene (2-phenyl-1-octene) or the two β-hexylstyrene isomers (cis- and trans-1-phenyl-1-octene) result.

Similarly, when using the pyridyl radical instead of the phenyl radical, compounds like 2-pyridyl-1-propene, cis- and trans-1-pyridyl-1-propene, 2-pyridyl-1-butene, cis- and trans-1-pyridyl-1-butene up to 2-phenyl-1-octene and the two isomers cis-1-pyridyl-1-octene and trans-1-pyridyl-1-octene result. Also included here, of course, are the isomers which differ by the position of the pyridine N atoms relative to the bond linking the vinyl group to the pyridyl group. If the phenyl or pyridyl radical is substituted by the abovementioned groups, compounds such as α-methylstyrenesulfonic acid (2-sulfophenyl-1-propene), α-methylnitrostyrene (2-nitrophenyl-1-propene), α-ethylstyrenesulfonic acid (2-sulfophenyl-1-butene), α-ethylnitrostyrene (2-nitrophenyl-1-butene), the similar pyridyl compounds or the cis/trans-isomers of the corresponding β-substituted compounds result. Of course, also included here are the isomers which result due to the position of the substituent on the benzene ring relative to the phenyl-vinyl bond or, for the substituted pyridine radical, due to the relative position of pyridine N atom, substituent and pyridyl-vinyl bond to one another.

By choice of an aromatic or heteroaromatic radical on the one hand and a C₂-C₆-alkenyl group on the other hand, it is possible if the two remaining radicals in turn are hydrogen also to derive, inter alia, substituted butadienes as free radical polymerizable vinyl compounds. The compounds 1- or 2-phenylbutadiene, 1- or 2-pyridylbutadiene, for example, may be employed with the corresponding cis/trans-isomers on the one hand and, in the case of the pyridyl radical, in turn the positional isomers due to the relative position of the N atom to the pyridyl-vinyl bond. Here also, very different substituents already mentioned above may occur on the aromatic or heteroaromatic compound.

Furthermore, according to the invention also aromatic or heteroaromatically substituted ethylenes, such as styrene, vinylpyridine, divinylbenzene, nitrostyrene, styrenesulfonic acid, vinyltoluene and, if appropriate, their isomers may be employed.

According to formula (I), in these monosubstituted ethylenes three of the radicals R¹, R², R³ and R⁴ are hydrogen and only one is an aromatic or heteroaromatic, unsubstituted or substituted group, i.e., in the corresponding sequence phenyl, pyridyl, vinylphenyl, nitrophenyl, sulfophenyl and methylphenyl. If desired, disubstituted ethylenes in which two or four radicals R¹, R², R³, R⁴ are hydrogen and the other radicals are aromatic or heteroaromatic groups can also be employed. Usually, these are symmetrically substituted stilbenes, such as 4,4′-diaminostilbene, 4,4′-dinitrostilbene, 4,4′-dinitrostilbene-2,2′-disulfonic acid, 4,4′-diaminostilbene-2,2′-disulfonic acid or their cis- or transisomers. Of course, it is also possible to employ those isomers which are different from one another with respect to the position of the substituent or of the substituents in the aromatic or heteroaromatic system relative to the vinyl group. According to formula (I), in these stilbenes two of the radicals R¹, R², R³ and R⁴ are hydrogen and the remaining radicals, which are not arranged vicinally, which are also identical, are in the corresponding sequence aminophenyl, nitrophenyl, nitrosulfophenyl and aminosulfophenyl.

Halogen-containing compounds, such as vinyl chloride, vinylidene chloride, vinyl fluoride, vinyl bromide and chloroprene (2-chloro-1,3-butadiene) may likewise be employed in the claimed compositions.

If R¹ and R³ or R² and R⁴ together form a saturated or unsaturated C₃—, C₄—, C₅- or C₆-alkylene bridge, then, for example, R², R⁴-substituted (or naturally completely equivalently thereto R¹, R³-substituted) compounds such as

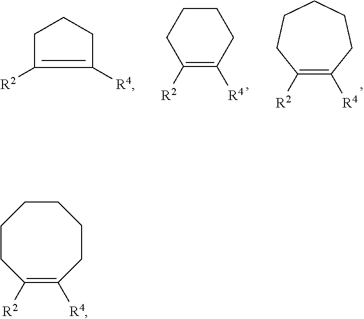

where R² and R⁴ independently of one another are preferably hydrogen or C₁-C₆-alkyl and methyl or ethyl are employed as particularly preferred alkyl radicals. These compounds may furthermore be additionally unsaturated in the alkylene bridge. In this case, compounds such as,

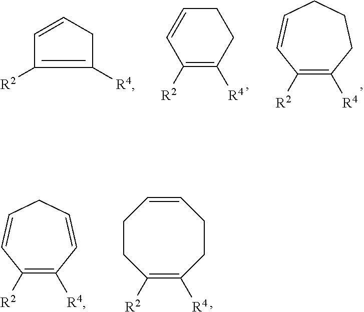

result, where the isomeric compounds should, of course, also be included which differ from one another with respect to the position of the double bonds to one another.

Furthermore, it is possible in compounds to replace up to two nonadjacent C atoms by N, NH, N(C₁-C₄-alkyl), N(C₆-C₁₀-aryl) or oxygen. The following compounds result as examples, where the compounds isomeric thereto should of course also be included here which result due to the relative position of the heteroatom/heteroatoms to the double bond/double bonds:

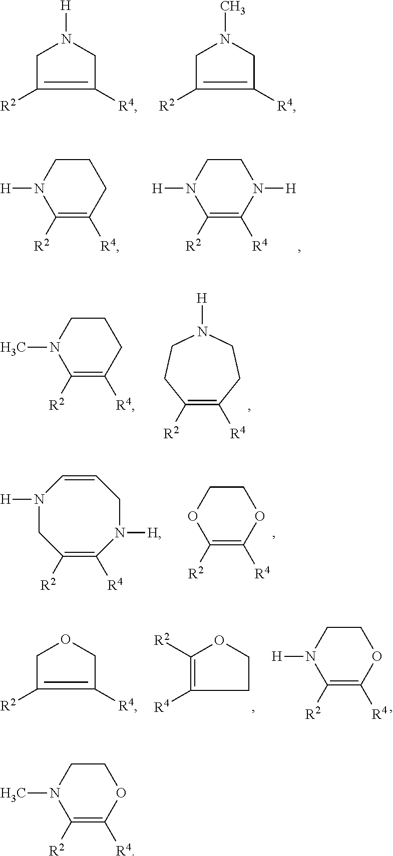

Preferred radicals in the N(C₁-C₄-alkyl) groups are methyl and ethyl, and in the N(C₆-C₁₀-aryl) groups phenyl, p-tolyl and mesityl.

Of course, it is possible not only to employ the free radical polymerizable vinyl compounds in compositions with their isomers, but also in compositions with one another, such as those obtained, for example, in the crude products during their preparation.

Furthermore preferred free radical polymerizable vinyl compounds are those of the formula (II)

H₂C═CZ⁴-Q-Z¹ (II),

where
Q is a chemical single bond, oxygen or a group —NZ²—;

### Z¹ is

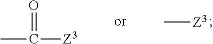

Z² is hydrogen, C₁-C₄-alkyl or together with Z³ is a saturated or unsaturated C₃-, C₄- or C₅-alkylene bridge, in which up to two nonadjacent C atoms may be replaced by N, NH, N(C₁-C₄-alkyl), N(C₆-C₁₀-aryl) or oxygen;
Z³ is hydrogen, hydroxyl, cyano, C₁-C₈-alkoxy, C₁-C₈-alkyl or a radical which together with Z² forms a saturated or unsaturated C₃-, C₄- or C₅-alkylene bridge, in which up to two non-adjacent C atoms may be replaced by N, NH, N(C₁-C₄-alkyl), N(C₆-C₁₀-aryl) or oxygen and up to two CH groups can be replaced by N; and
Z⁴ is hydrogen, C₁-C₄-alkyl.

If Q is a chemical single bond in formula (II), the group Z¹ is either a radical —CO—Z³ or the group Z³ on its own. Possible radicals Z³ in this case are firstly particularly hydroxyl and C₁-C₈-alkoxy such as, for example, methoxy, ethoxy, propoxy, t-butoxy or n-butoxy, but also 2-ethylhexoxy, in the latter case cyano.

Z⁴ is hydrogen or C₁-C₄-alkyl groups, hydrogen and methyl being preferred radicals. Acrylic acid, methacrylic acid, the corresponding methyl, ethyl, propyl, t-butyl, n-butyl and 2-ethylhexyl esters, and acrylonitrile and methacrylonitrile therefore result as preferred free radical polymerizable vinyl compounds of the formula (II) in the compositions according to the invention.

The free radical polymerizable vinyl compounds of the formula (II) which are in the compositions according to the invention can furthermore comprise oxygen as the variable Q. Among these compounds, the vinyl esters are preferred in which the group Z¹ corresponds to the radical —CO—Z³, and also the vinyl ethers in which the group Z¹ is identical to the group Z³ and in which Z³ is preferably a C₁-C₈-alkyl group, such as, for example methyl, ethyl, n-propyl, isopropyl, n-butyl, isobutyl, sec-butyl, tert-butyl or 2-ethylhexyl.

If the variable Q is a group —NZ²—, Z¹ is preferably a group —CO—Z³.

Beside those already mentioned, suitable radicals Z³ are also those, which together with the group —NZ²— form a saturated or unsaturated 5- to 7-membered ring. Examples of such radicals are:

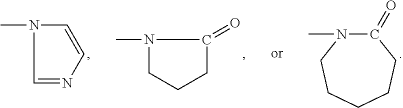

Among them the N-pyrrolidinonyl radical and the N-caprolactamyl radical are preferred.

The C₆-C₁₀-aryls mentioned in the radicals N(C₆-C₁₀-aryl) of the groups Z² and Z³ preferably include phenyl groups which can be substituted by one or more C₁-C₄-alkyls. In the case of the presence of two or more substituents, the sum of C atoms should not be more than four. Exemplary substitution patterns on the benzene ring are, for example, three methyl groups, one methyl and one propyl group or alternatively only one t-butyl group. Further examples of C₁-C₄-alkyl radicals which can also be present in the radicals N(C₁-C₄-alkyl) of the groups Z² and Z³ have already been mentioned above. Possible C₁₀-aryl is furthermore also a naphthyl radical.

Preferred free radical polymerizable vinyl compounds in the compositions according to the invention are N-vinylformamide, N-vinyl-2-pyrrolidone, N-vinyl-ε-caprolactam, acrylic acid, vinyl acetate, acrylonitrile, methyl acrylate, n-butyl acrylate and the abovementioned C₁-C₈-alkyl vinyl ethers.

The inhibition composition comprises metal ions, halogen ions and a ligand having a donor atom selected from oxygen, nitrogen, sulfur, phosphorus and a combination thereof. The metal ions are selected from ions of Ti, Mo, Re, Ru, Fe, Rh, Ni, Pd, Co, Os, Cu and any combination thereof. The metal ions are in oxidated states, preferably having the highest valence and examples include Fe³⁺, Cu²⁺ etc.

O-containing ligands comprise such as sulfate, acetate, oxalate, citrate, tartrate, lactate, gluconate or acetylacetonate (acac). Further exclusively or mainly O-containing ligands for metal ions, e.g., Fe(III), however, may also be polycyclic ethers such as spherands, cryptands, cryptaspherands, hemispherands, coronands or open-chain representatives of these ethers, and podands. Besides oxygen atoms, many representatives of these compound classes also additionally comprise nitrogen and/or sulfur and/or phosphorus and/or arsenic atoms.

It is furthermore possible to use N-containing chelate ligands such as ethylenediamine (en), 1,10-phenanthroline (phen), 1,8-naphthpyridine (napy), 2,2′-bipyridine (pipy) 5,5′-alkylsubstituted-2,2-bipyridine, dibenzo(b,i)-1,4,8,11-tetraaza-(14)-annulene (taa), and porphyrin ligand. Other N-containing ligands are phthalocyanine and derivatives thereof.

Using N,O-containing ligands, such as ethylenediaminetetraacetic acid (EDTA) or nitrilotriacetic acid (NTA), hydroxylquinoline, and salicylic acid are also possible. The preparation of these N,O-containing ligands is well known and is generally carried out by condensation of aromatic or heteroaromatic α-hydroxyaldehydes with an aliphatic or aromatic diamine or polyamine.

S-containing ligands, e.g., thiol based and dithio carbonates like benzenethiol and benzodithioic acid, may also be used.

Metal ions and halogen ions may coexist in metal halides. For example, in the case of the Fe halides, the Fe(III) salts of Cl and Br, are preferably employed.

Metal ions may also come from metal pseudohalide compounds. Fe pseudohalide compounds which may be employed according to the invention include, for example, [Fe(CN)₆]³⁻ and also thiocyanate complexes of the series [Fe(SCN)₃₋ₓ(H₂O)^{3+x}]^{x+} (x=0, 1, 2). The counterions used for negatively charged complex ions mentioned above are preferably H⁺, Na⁺, K⁺ and ammonium ions NH₄⁺ and also N(CH₃)₄⁺. In the case of the positively charged complex ions mentioned, Cl⁻, Br⁻, I⁻, SO₄²⁻, H₃CCO₂⁻, CrO₄²⁻, BF₄⁻ and also B(C₆H₅)₄⁻ are preferably employed as counterions.

In some embodiments, the ligand is selected from

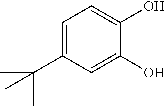

4-tert-<butylcatechol,

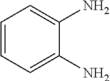

o-phenyldiamine,

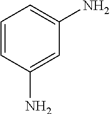

m-phenyldiamine,

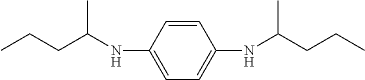

n,n-di-sec-butyl-1,4-phenylenediamine,

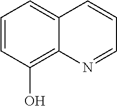

8-hydroxyqionoline,

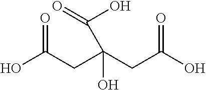

citric acid,

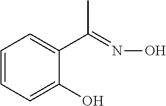

salicylaldoxime,

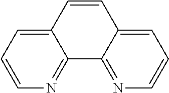

1,10-phenanthroline,

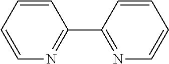

2,2′-bipyridine,

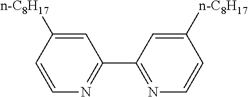

dinonylbipyridine,

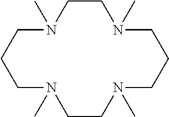

1,4,8,11-tetramethyl-1,4,8,11-tetraaza-cyclotetradecane,

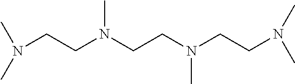

1,1,4,7,10,10-hexamethyl-triethylenetetramine, and

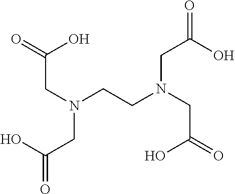

ethylenediaminetetraacetic acid.

In some embodiments, the at least one free radical polymerizable vinyl compound is styrene, and the inhibition composition comprises at least one of FeCl₃ and CuCl₂, and at least one of 4-tert-butylcatechol, 2,2′-bipyridine, n,n-di-sec-butyl-1,4-phenylenediamine, dinonylbipyridine, 1,1,4,7,10,10-hexamethyl-triethylenetetramine, o-phenyldiamine, m-pheyldiamine, 8-hydroxyqionoline, salicyldoxime, ethylenediaminetetraacetic acid, citric acid, 1,10-phenanthroline, and 1,4,8,11-tetramethyl-1,4,8,11-tetraaza-cyclotetradecane.

In some embodiments, the at least one free radical polymerizable vinyl compound is styrene, and the inhibition composition comprises CuCl₂ and at least one of 2,2′-bipyridine, o-phenyldiamine, n,n-di-sec-butyl-1,4-phenylenediamine, 8-hydroxyqionoline, 1,10-phenanthroline, dinonylbipyridine, and 1,1,4,7,10,10-hexamethyl-triethylenetetramine.

In some embodiments, the at least one free radical polymerizable vinyl compound is styrene, and the inhibition composition comprises FeCl₃ and at least one of 2,2′-bipyridine, 4-tert-butylcatechol, o-phenyldiamine, m-pheyldiamine, n,n-di-sec-butyl-1,4-phenylenediamine, 8-hydroxyqionoline, ethylenediaminetetraacetic acid, citric acid, salicyldoxime, 1,10-phenanthroline, dinonylbipyridine, 1,4,8,11-tetramethyl-1,4,8,11-tetraaza-cyclotetradecane and 1,1,4,7,10,10-hexamethyl-triethylenetetramine.

It is further possible for the composition, if appropriate to further comprise nitro compound, additionally also to contain one or more costabilizers from the group consisting of the aromatic nitroso compounds, phenothiazines, quinones, hydroquinones and ethers thereof, phenols and ethers thereof, hydroxylamines and phenylenediamines.

Suitable aromatic nitroso compounds are, for example, p-nitrosophenol, p-nitroso-o-cresol or p-nitroso-N,N′-diethylaniline.

Further costabilizers can also be substituted phenols or hydroquinones, for example the following: 4-tert-butylpyrocatechol, methoxyhydroquinone, 2,6-di-tert-butyl-4-methylphenol, n-octadecyl β-(3,5-di-tert-butyl-4-hydroxyphenyl)propionate, 1,1,3-tris-(2-methyl-4-hydroxy-5-tert-butylphenyl)butane, 1,3,5-trimethyl-2,4,6-tris(3,5-di-tert-butyl-4-hydroxybenzyl)benzene, 1,3,5-tris(3,5-di-tert-butyl-4-hydroxybenzyl)isocyanurate, 1,3,5-tris-[β-(3,5-di-tert-butyl-4-hydroxyphenyl)propionyloxy-ethyl] isocyanurate, 1,3,5-tris-(2,6-dimethyl-3-hydroxy-4-tert-butylbenzyl) isocyanurate or pentaerythrityl tetrakis[β-(3,5-di-tert-butyl-4-hydroxyphenyl)propionate].

In some embodiments, the inhibition composition comprises FeCl₃, n,n-di-sec-<butyl-1,4-phenylenediamine and at least one of

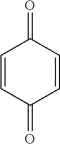

benzoquinone,

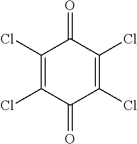

chloranil, and

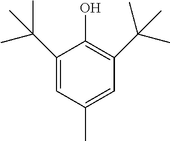

butylated hydroxytoluene.

Metal ions and halogen ions may separately exist in different compounds before adding into the free radical polymerizable vinyl compound. In some embodiments, the at least one free radical polymerizable vinyl compound is styrene, and the inhibition composition comprises Fe₂(SO₄)₃, n,n-di-sec-butyl-1,4-phenylenediamine and NaCl.

In some embodiments, the at least one free radical polymerizable vinyl compound is styrene, and the inhibition composition comprises FeCl₃, n,n-di-sec-butyl-1,4-phenylenediamine and FeCl₂.

Nitroxyl compound of a secondary amine having no hydrogen atom on α-C atom described herein refers to N-oxyl compound of a secondary amine which carries no hydrogen atoms on the α-C atoms and nitroxyl compounds of a secondary amine having no hydrogen atoms on the α-carbon atoms as disclosed in, e.g., U.S. Pat. No. 6,200,460 and U.S. Pat. No. 6,475,348. Compositions and methods disclosed herein effectively inhibit premature polymerization of free radical polymerizable vinyl compounds using cheap materials.

Taking account of the particular circumstances, it is in each case possible for the person skilled in the art to determine an optimized ratio of nitro compounds, costabilizers and other components in the inhibition composition by means of preliminary tests.

The inhibition composition may be added in an effective amount in solid form, as a suspension or as a solution using a suitable solvent before or during purification or distillation in order to suppress premature polymerization. In specific cases, it may also be necessary to add components of the inhibition composition separately and preferably at spatially different positions.

Suspensions or solutions of the inhibition composition are preferably prepared using water. Furthermore, alkanols, such as methanol, ethanol, propanol, and n-, i- and t-butanol, if appropriate as a mixture with water, are preferably employed. These alcohols or their mixtures with water are preferably used in the case of the corresponding esters of acrylic acid and alkylacrylic acid.

Furthermore, suspending agents or solvents which can also be used, if appropriate as a mixture with alcohols and water, are ketones such as, for example, acetone, methyl ethyl ketone, methyl propyl ketone, methyl butyl ketone, diols such as glycol or propylene glycol and their alkyl mono- or diethers, oligomeric or polymeric ethylene glycols (polyethylene glycols) and propylene glycols (polypropylene glycols) and their alkyl ethers, diamines such as ethylenediamine or propylenediamine and their alkyl mono- or diimino ethers, oligomeric or polymeric ethylenediamines (polyethyleneimines) and their alkylimino ethers. Of course, the free radical polymerizable vinyl employed or their mixtures may also be used as solvents or suspending agents.

Furthermore, crude product mixtures may also be employed for this purpose. If, for example, furnace oil, a mixture obtained in the dehydrogenation of ethylbenzene, which consists mainly of styrene, ethylbenzene, toluene and additionally further substituted aromatics, is to be purified by distillation, this mixture may be employed as a solvent and/or suspending agent.

Furthermore, the inhibition composition may be generally employed for the stabilization of organic materials against the damaging action of free radicals. Organic materials here are understood as meaning, for example, plastics such as polyacrylates, polyolefins, PVC, etc. These are furthermore binders, such as are used, for example, for automotive lacquers or exterior paints (wood preservatives, masonry paints, etc.), or mineral oils and lubricants. The compositions according to the invention can also be used as a component in appropriate formulations for the protection of biological/organic material such as, for example, the skin in skin protection and sunscreen compositions. Of course, toxicologically questionable additives such as, for example, nitro compounds are not possible here. Moreover, the inhibition composition suitable for cosmetic applications can be effected by a person skilled in the art familiar with formulations of this type.

### EXAMPLES

The following examples are included to provide additional guidance to those of ordinary skill in the art in practicing the claimed invention. Accordingly, these examples do not limit the invention as defined in the appended claims.

All materials were obtained from Sigma-Aldrich (Shanghai) Trading Co., Ltd., Shanghai, China.

### Example 1

Uninhibited styrene samples (5 mL each) obtained by filtering commercially obtained styrene through a pad of inhibitor remover to remove 4-tert-butylcatechol was placed in a test tube and was dosed with desired inhibition composition. The inhibition compositions were methanol solutions comprising metal halides and ligands as listed in table 1. The tube was then capped with a septum. The capped tube was purged with argon for 3 minutes. The sample was heated in a 110° C. oil bath for one hour (some were heated for two, three or four hours) and then removed from the tubes. The heated sample was then placed in 45 mL of methanol to precipitate polystyrene. The solid polystyrene was collected by filtration on a pre-weighed one-micron filter paper; dried in a 105° C. oven and weighed. The weight percentage of formed polystyrene over the uninhibited styrene is shown in table 1 below. For some samples, a small amount was taken out and characterized with ¹H NMR. The percentage of characteristic peak of polystyrene at 1.8 ppm based on the sum of characteristic peak of uninhibited styrene at 5.5 ppm and characteristic peak of polystyrene at 1.8 ppm was also listed in table 1 below.

TABLE 1

| | inhibition composition | | | | | | | | |
|---|---|---|---|---|---|---|---|---|---|
| | materials | | dosage (ppm) | | polystyrene percentage (%) | | | | |
| sample | metal | | metal | | precipitation | | | | NMR |
| no. | halide | ligand | halide | ligand | 1 hour | 2 hours | 3 hours | 4 hours | 1 hour |
| 1 | N/A | N/A | 0 | 0 | 4.55 | | | | |
| 2 | N/A | 4-tert-butylcatechol | 0 | 62 | 2.94 | | | | |
| 3 | N/A | o-phenyldiamine | 0 | 40.5 | 2.53 | | | | |
| 4 | N/A | m-phenyldiamine | 0 | 40.5 | 2.87 | | | | |
| 5 | N/A | n,n-di-sec-butyl- | 0 | 82 | 2.27 | | | | |
| | | 1,4- | | | | | | | |
| | | phenylenediamine | | | | | | | |
| 6 | N/A | 8-hydroxyqionoline | 0 | 54 | 3.89 | | | | |
| 7 | N/A | citric acid | 0 | 78 | 4.3 | | | | |
| 8 | N/A | salicyldoxime | 0 | 51 | 3.28 | | | | |
| 9 | N/A | 1,10- | 0 | 134 | 3.3 | | | | |
| | | phenanthroline | | | | | | | |
| 10 | N/A | 2,2′-bipyridine | 0 | 58 | 3.64 | | | | |
| 11 | N/A | dinonylbipyridine | 0 | 152 | 4.41 | | | | |
| 12 | N/A | 1,4,8,11- | 0 | 95 | 3.94 | | | | |
| | | tetramethyl- | | | | | | | |
| | | 1,4,8,11-tetraaza- | | | | | | | |
| | | cyclotetradecane | | | | | | | |
| 13 | N/A | 1,1,4,7,10,10- | 0 | 86 | 3.58 | | | | |
| | | hexamethyl- | | | | | | | |
| | | triethylenetetramine | | | | | | | |
| 14 | N/A | 2,2′-bipyridine | 0 | 750 | 4 | | | | |
| 15 | CuCl₂ | N/A | 250 | 0 | 2.2 | | | | 2.1 |
| 16 | CuCl₂ | N/A | 500 | 0 | 0 | | | | 0 |
| 17 | CuCl₂ | N/A | 750 | 0 | 0 | | | | 0 |
| 18 | CuCl₂ | N/A | 1000 | 0 | 0 | | | | 0 |
| 19 | CuCl₂ | 2,2′-bipyridine | 100 | 116 | 0 | | | | 0 |
| 20 | CuCl₂ | 2,2′-bipyridine | 100 | 232 | 0 | | | | 0 |
| 21 | CuCl₂ | 2,2′-bipyridine | 100 | 348 | 0 | | | | 0 |
| 22 | CuCl₂ | 2,2′-bipyridine | 250 | 116 | 0 | | | | 0 |
| 23 | CuCl₂ | 2,2′-bipyridine | 250 | 232 | 0 | | | | 0 |
| 24 | CuCl₂ | 2,2′-bipyridine | 250 | 348 | 0 | | | | 0 |
| 25 | CuCl₂ | 2,2′-bipyridine | 25 | 110 | 0 | | | | |
| 26 | CuCl₂ | 2,2′-bipyridine | 25 | 29 | 0 | | | | |
| 27 | CuCl₂ | 2,2′-bipyridine | 50 | 110 | 0 | | | | |
| 28 | CuCl₂ | 2,2′-bipyridine | 50 | 110 | | | 0 | | |
| 29 | CuCl₂ | 2,2′-bipyridine | 100 | 110 | 0 | | | | |
| 30 | CuCl₂ | 2,2′-bipyridine | 100 | 110 | | | 0 | | |
| 31 | CuCl₂ | N/A | 50 | 0 | 2.71 | | | | |
| 32 | CuCl₂ | 4-tert-butylcatechol | 50 | 62 | 2.76 | | | | |
| 33 | CuCl₂ | o-phenyldiamine | 50 | 40.5 | 2.25 | | | | |
| 34 | CuCl₂ | m-phenyldiamine | 50 | 40.5 | 4.05 | | | | |
| 35 | CuCl₂ | n,n-di-sec-butyl- | 50 | 82 | 0 | | | | |
| | | 1,4- | | | | | | | |
| | | phenylenediamine | | | | | | | |
| 36 | CuCl₂ | 8-hydroxyqionoline | 50 | 54 | 2.73 | | | | |
| 37 | CuCl₂ | ethylenediaminetetraacetic | 50 | 109 | 3.64 | | | | |
| | | acid | | | | | | | |
| 38 | CuCl₂ | citric acid | 50 | 71 | 5.14 | | | | |
| 39 | CuCl₂ | salicyldoxime | 50 | 56 | 2.94 | | | | |
| 40 | CuCl₂ | 1,10- | 50 | 134 | 1.90 | | | | |
| | | phenanthroline | | | | | | | |
| 41 | CuCl₂ | 2,2′-bipyridine | 50 | 58 | 0 | | | | |
| 42 | CuCl₂ | dinonylbipyridine | 50 | 152 | 0 | | | | |
| 43 | CuCl₂ | 1,4,8,11- | 50 | 95 | 4.45 | | | | |
| | | tetramethyl- | | | | | | | |
| | | 1,4,8,11-tetraaza- | | | | | | | |
| | | cyclotetradecane | | | | | | | |
| 44 | CuCl₂ | 1,1,4,7,10,10- | 50 | 86 | 0 | | | | |
| | | hexamethyl- | | | | | | | |
| | | triethylenetetramine | | | | | | | |
| 45 | FeCl₃ | 2,2′-bipyridine | 30 | 29 | 0 | | | | |
| 46 | FeCl₃ | 2,2′-bipyridine | 60 | 56 | 0 | | | | |
| 47 | FeCl₃ | 2,2′-bipyridine | 120 | 112 | 0 | | | | |
| 48 | FeCl₃ | 2,2′-bipyridine | 120 | 112 | | 0 | | | |
| 49 | FeCl₃ | 2,2′-bipyridine | 120 | 112 | | | 0 | | |
| 50 | FeCl₃ | 2,2′-bipyridine | 120 | 112 | | | | 0 | |
| 51 | FeCl₃ | N/A | 60 | 0 | 3.07 | | | | |
| 52 | FeCl₃ | 4-tert-butylcatechol | 60 | 62 | 2.98 | | | | |
| 53 | FeCl₃ | o-phenyldiamine | 60 | 40.5 | 0 | | | | |
| 54 | FeCl₃ | m-phenyldiamine | 60 | 40.5 | 0 | | | | |
| 55 | FeCl₃ | n,n-di-sec-butyl- | 60 | 82 | 0 | | | | |
| | | 1,4- | | | | | | | |
| | | phenylenediamine | | | | | | | |
| 56 | FeCl₃ | 8-hydroxyqionoline | 60 | 54 | 0 | | | | |
| 57 | FeCl₃ | ethylenediaminetetraacetic | 60 | 109 | 2.23 | | | | |
| | | acid | | | | | | | |
| 58 | FeCl₃ | citric acid | 60 | 71 | 0.85 | | | | |
| 59 | FeCl₃ | salicyldoxime | 60 | 56 | 0 | | | | |
| 60 | FeCl₃ | 1,10-phenanthroline | 60 | 134 | 2.46 | | | | |
| 61 | FeCl₃ | 2,2′-bipyridine | 60 | 58 | 0 | | | | |
| 62 | FeCl₃ | dinonylbipyridine | 60 | 152 | 0 | | | | |
| 63 | FeCl₃ | 1,4,8,11- | 60 | 95 | 0 | | | | |
| | | tetramethyl- | | | | | | | |
| | | 1,4,8,11-tetraaza- | | | | | | | |
| | | cyclotetradecane | | | | | | | |
| 64 | FeCl₃ | 1,1,4,7,10,10- | 60 | 86 | 0 | | | | |
| | | hexamethyl- | | | | | | | |
| | | triethylenetetramine | | | | | | | |

### Example 2

Sample of uninhibited styrene (100 mL each) obtained by filtering commercially obtained styrene through a pad of inhibitor remover to remove 4-tert-butylcatechol was placed in a 3-neck round-bottom flask equipped with a condenser, an argon dispering tube and a septum and was dosed with the inhibition composition. The inhibition compositions were methanol solutions comprising metal materials, and ligands, and in sample numbers 79-84, third materials, as listed in table 2. The sample, with a magnetic stirring bar inside the flask, was purged with argon for 15 minutes at room temperature and then placed in a 110° C. oil bath. The sample was continuously purged with argon gas while being stirred. Every hour, 5 mL of sample was taken with a graduated syringe and placed in 45 mL of methanol for precipitating polystyrene. The solid polystyrene was collected by filtration on a pre-weighed one-micron filter paper, dried in a 105° C. oven and weighed. The weight percentage of formed polystyrene over the uninhibited styrene at different heating time lengths (i.e., 1 hour to 7 hours in the oil bath) is shown in table 2 below.

TABLE 2

| | inhibition composition | | | | | | | | | | | | |
|---|---|---|---|---|---|---|---|---|---|---|---|---|---|
| | materials | | | dosage (ppm) | | | | | | | | | |
| sample | metal | | third | | | third | polystyrene percentage (%) | | | | | | |
| No. | material | ligand | material | metal material | ligand | material | 1 hour | 2 hours | 3 hours | 4 hours | 5 hours | 6 hours | 7 hours |
| 65 | FeCl₃ | n,n-di-sec- | N/A | 60 | 82 | N/A | 0 | 0 | 0 | 0.62 | 2.55 | | |
| | | butyl-1,4- | | | | | | | | | | | |
| | | phenylene | | | | | | | | | | | |
| | | diamine | | | | | | | | | | | |
| 66 | FeCl₃ | n,n-di-sec- | N/A | 60 | 164 | N/A | 0 | 0 | 0 | 0 | 0.52 | 1.59 | 3.85 |
| | | butyl-1,4- | | | | | | | | | | | |
| | | phenylene | | | | | | | | | | | |
| | | diamine | | | | | | | | | | | |
| 67 | FeCl₃ | n,n-di-sec- | N/A | 60 | 246 | N/A | 0 | 0 | 0 | 0 | 0 | 0.56 | 1.55 |
| | | butyl-1,4- | | | | | | | | | | | |
| | | phenylene | | | | | | | | | | | |
| | | diamine | | | | | | | | | | | |
| 68 | FeCl₃•6H₂O | n,n-di-sec- | N/A | 100 | 82 | N/A | 0 | 0 | 0 | | | | |
| | | butyl-1,4- | | | | | | | | | | | |
| | | phenylene | | | | | | | | | | | |
| | | diamine | | | | | | | | | | | |
| 69 | FeCl₃ | n,n-di-sec- | Benzo- | 60 | 82 | 92 | 0 | 0 | 0 | 0 | 0.8 | 1.79 | 2.73 |
| | | butyl-1,4- | quinone | | | | | | | | | | |
| | | phenylene | | | | | | | | | | | |
| | | diamine | | | | | | | | | | | |
| 70 | FeCl₃ | n,n-di-sec- | chloranil | 60 | 82 | 92 | 0 | 0 | 0 | 0 | 0.55 | | |
| | | butyl-1,4- | | | | | | | | | | | |
| | | phenylene | | | | | | | | | | | |
| | | diamine | | | | | | | | | | | |
| 71 | FeCl₃ | n,n-di-sec- | butylated | 60 | 82 | 300 | 0 | 0 | 0 | 0 | 0.34 | 0.88 | |
| | | butyl-1,4- | hydroxy- | | | | | | | | | | |
| | | phenylene | toluene | | | | | | | | | | |
| | | diamine | | | | | | | | | | | |
| 72 | FeCl₃ | n,n-di-sec- | butylated | 60 | 82 | 600 | 0 | 0 | 0 | 0 | 0 | 0.34 | 0.4 |
| | | butyl-1,4- | hydroxy- | | | | | | | | | | |
| | | phenylene | toluene | | | | | | | | | | |
| | | diamine | | | | | | | | | | | |
| 73 | Fe₂(SO₄)₃ | n,n-di-sec- | NaCl | 74 | 64 | 82 | 0 | 0 | 0 | | | | |
| | | butyl-1,4- | | | | | | | | | | | |
| | | phenylene | | | | | | | | | | | |
| | | diamine | | | | | | | | | | | |
| 74 | FeCl₃ | n,n-di-sec- | FeCl₂ | 60 | 82 | 73 | 0 | 0 | 0 | 0 | 0 | 0 | 0 |
| | | butyl-1,4- | | | | | | | | | | | |
| | | phenylene | | | | | | | | | | | |
| | | diamine | | | | | | | | | | | |

While only certain features of the invention have been illustrated and described herein, many modifications and changes will occur to those skilled in the art. It is, therefore, to be understood that the appended claims are intended to cover all such modifications and changes as fall within the true spirit of the invention.

1. A composition comprising:
at least one free radical polymerizable vinyl compound; and
an active amount of inhibition composition comprising metal ions, halogen ions and a ligand having a donor atom selected from oxygen, nitrogen, sulfur, phosphorus and a combination thereof, wherein the metal ions are selected from ions of Ti, Mo, Re, Ru, Fe, Rh, Ni, Pd, Co, Os, Cu and any combination thereof, and wherein the metal ions and halogen ions are present as metal halides;
wherein the composition is free of a nitroxyl compound of a secondary amine having no hydrogen atom on α-C atom.

2. The composition of claim 1, wherein the at least one free radical polymerizable vinyl compound comprises styrene, the metal halides comprise at least one of FeCl₃ and CuCl₂, and the ligand comprises at least one of 2,2′-bipyridine, 4-tert-butylcatechol, n,n-di-sec-butyl-1,4-phenylenediamine, dinonylbipyridine, o-phenyldiamine, m-pheyidiamine, 8-hydroxyqionoline, ethylenediaminetetraacetic acid, salicyldoxime, citric acid, 1,10-phenanthroline, 1,4,8,11-tetramethyl-1,4,8,11-tetraaza-cyclotetradecane and 1,1,4,7,10,10-hexamethyl-triethylenetetramine.

3. The composition of claim 1, wherein the ligand is selected from 4-tert-butylcatechol, o-phenyldiamine, 2,2′-bipyridine, m-phenyldiamine, 8-hydroxyquinoline, 1,1,4,7,10,10-hexamethyl-triethylenetetramine, dinonylbipyridine, salicyldoxime, n,n-di-sec-butyl-1,4-phenylenediamine, 1,10-phenanthroline, 1,4,8,11-tetramethyl-1,4,8,11-tetraaza-cyclotetradecane, ethylenediaminetetraacetic acid, and citric acid.

4. The composition of claim 1, further comprising at least one of nitro compounds and quinomethides.

5. The composition of claim 1, further comprising at least one of nitroso, benzoquinone, hydroquinone and ether thereof, hydroxylamine, phenothiazine, phenol and ether thereof, and phenyldiamines.

6. The composition of claim 1, further comprising at least one of benzoquinone, chloranil, and butylated hydroxytoluene.

7.-19. (canceled)

20. A composition comprising:
at least one free radical polymerizable vinyl compound; and
an active amount of inhibition composition comprising metal ions, halogen ions and a ligand having a donor atom selected from oxygen, nitrogen, sulfur, phosphorus and a combination thereof, wherein the metal ions are selected from ions of Ti, Mo, Re, Ru, Fe, Rh, Ni, Pd, Co, Os, Cu and any combination thereof, and wherein the metal ions and halogen ions are present as metal halides:
wherein when the metal ions comprise Fe ions, the composition is free of a nitroxyl compound of a secondary amine having no hydrogen atom on α-C atom.
